(19) United States
(12) Patent Application Publication
(10) Pub. No.: US 2005/0126331 A1
(43) Pub. Date: Jun. 16, 2005

(54) Covering sheath for a bicycle component

(75) Inventor: Giuseppe Dal Pra, Zane (Vicenza) (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: Campagnolo, S.r.l., Vicenza (IT)

(21) Appl. No.: 10/835,674

(22) Filed: Apr. 30, 2004

(30) Foreign Application Priority Data
Apr. 30, 2003 (EP) 03425278.3

(51) Int. Cl. G05G 1/04

(52) U.S. Cl. 74/558.5

(57) ABSTRACT

A covering hood for a bicycle component that is gripped or grasped when in use is provided. The hood may be used, for example, for covering a supporting body of an integrated device for controlling the brake and derailleur of a bicycle. The hood comprises areas with differentiated compliance.

### FIELD OF THE INVENTION

The present invention relates to a covering sheath or hood for a bicycle component that is gripped or grasped when in use. The invention relates in general to a hood applicable to any bicycle component that is designed to be gripped or grasped when used, such as for example a portion of bicycle handlebar. Particularly the component can be the straight or curved ends of the handlebar itself, or an auxiliary gripping appendage that can be installed on the handlebar. This can be for example, a lever for actuation of a device on board the bicycle, such as a lever for brake actuation or a lever for derailleur actuation of a bicycle.

### BACKGROUND

In the specific case of an integrated control device used in competition bicycles, the hood according to the invention is designed to be applied to the support of the control device mounted on each of the curved ends of the handlebar. In effect, the supporting bodies of the right and left devices serve as two extensions of the handlebar that a cyclist can easily grip.

An integrated control device normally comprises a lever for brake actuation and a controller for the front or rear derailleur. In the case where a derailleur is controlled by an electrical actuator, electrical switches can be used that are operated by respective push-buttons that are carried by the supporting body of the controller and are covered by the sheath or hood. Furthermore, the control device may also comprise one or more push-buttons electrically connected to a cycle computer that enable a cyclist to interact in the selection of the different operating modes of a cycle computer, said selection being known as “mode select.” Such devices enable the cyclist to grip the handlebar in a position corresponding to the respective supporting bodies and to actuate the brake, derailleur, or operating modes of the cycle computer without, however, changing hand position on the supporting body.

The use of a hood, of substantially uniform thickness, covering the aforesaid supporting body of the control device, which functions as a protective element and at the same time enables a more convenient grip is known. The applicant has determined that the use of hoods, normally consisting of elastomeric material, on the aforesaid control devices involves some drawbacks.

Firstly, prolonged gripping of the supporting body or of the ends of the handlebar (whether straight or curved) by the cyclist, in particular during competitions, may cause discomfort in the areas of the cyclist's hand that are subjected to greater pressure. This discomfort can even lead to bone lesions or to micro-abrasions of the skin.

Another drawback is that the covering of a support body by a hood sometimes renders actuation of electrical push-buttons set thereunder difficult for the cyclist.

### SUMMARY

The present invention relates to a hood for covering a bicycle control device wherein the hood comprises a main body and at least one area having a differentiated softness or compliance with respect to the main body of the hood. When the area is of greater compliance, it is located in a position that comes in contact with a portion of a cyclist's hand when the device is used. Alternatively/additionally, the hood may comprise at least one area of reduced compliance that can be located in a position corresponding to the location of push-buttons.

### BRIEF DESCRIPTION OF THE DRAWINGS

The purposes and advantages above mentioned will be illustrated in greater detail in what follows with reference to the appended drawings, which are provided purely by way of non-limiting example and wherein:

FIG. 1 is a perspective view of a first embodiment of the covering sheath according to the invention, in use with a known integrated control device;

FIG. 2 is the control device of FIG. 1 provided with the sheath according to the invention, applied to a curved handlebar and with the cyclist's hand in a normal position of use;

FIG. 3 is a top plan view of an alternate embodiment of the sheath of the invention, applied to a known integrated control device;

FIG. 4 is a side view of another alternate embodiment of the sheath according to the invention;

FIG. 5 is a side view of a further alternate embodiment of the sheath according to the invention, in use with an electrical gear-changer control device;

FIG. 6 is a perspective view of a further alternate embodiment of the sheath according to the invention, in use with an electrical gear-changer control device;

FIGS. 7 to 12 illustrate cross-sectional views according to a longitudinal vertical plane of alternate embodiments of the sheath;

FIG. 13 is a cross-sectional view taken along line XIII-XIII of the sheath of FIG. 6; and

FIG. 14 is a side view of another alternate embodiment of the sheath according to the invention

### DETAILED DESCRIPTION OF THE PREFERRED EMBODIMENTS

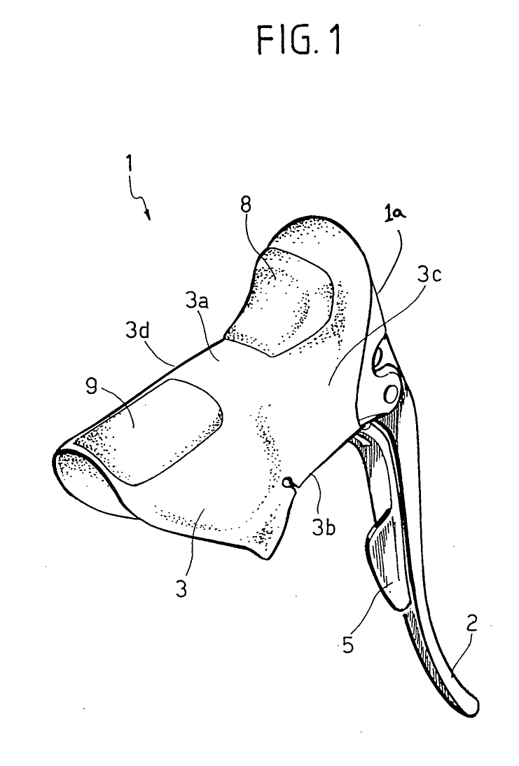

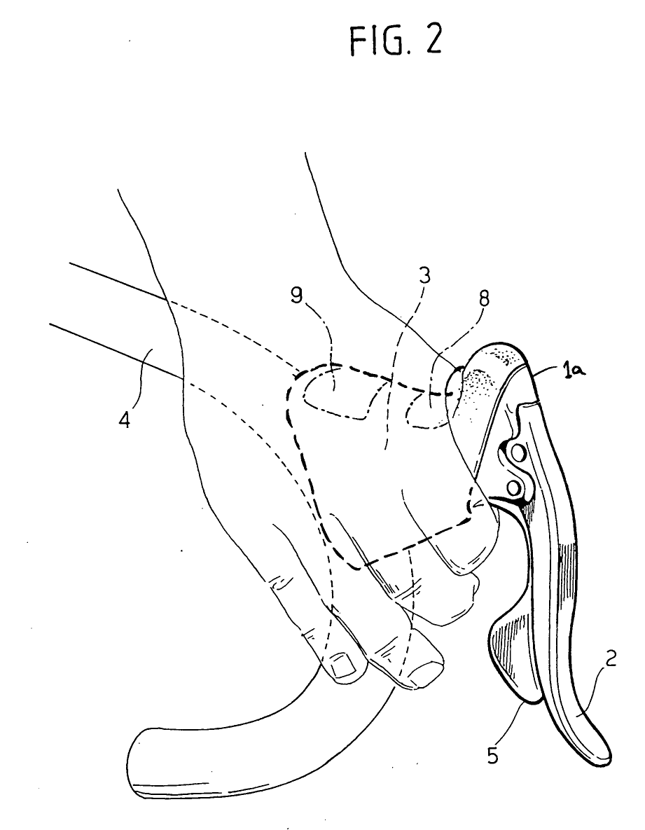

FIGS. 1 and 2 depict an integrated control device 1 for a brake and a bicycle derailleur. The device 1 is a right-hand version, i.e., mounted on the right end of a handlebar 4. (It is also evident that the following description may be adapted for a control device mounted on the left.) The device illustrated, excluding the sheath 5 according to the invention, may be of any known type.

The device 1 comprises a brake lever 2, supported in an articulated way by a supporting body 1a that is covered by a sheath or hood 3 made of an elastomeric material. The body 1a can be fixed in a conventional way (FIG. 2) to a bicycle handlebar 4. In the case of the version illustrated in FIGS. 1 and 2, the supporting body 1a of the device 1 integrates an actuation mechanism of one of the two bicycle derailleurs, including a lever 5 positioned behind the brake lever 2 and a further lever 5′ (shown in FIG. 14), that is positioned on the inside (i.e., facing the center of the handlebar). The two levers actuate the derailleur in the two opposite directions of gear-shifting, i.e., upshifting and downshifting.

The hood 3 that covers the supporting body 1a, of the device 1 presents a generally tubular conformation, with a top wall 3a, a bottom wall 3b, an external side wall 3c, and an internal side wall 3d. The hood 3 can also exclude the aforesaid bottom wall. When the hood is designed to be inserted on the ends of the handlebar, whether these are straight or curved, it may have a substantially cylindrical conformation, the cylinder possibly being closed or open.

FIGS. 1 and 2, show the top wall 3a with two areas 8, 9 of increased compliance compared to the main body of the hood 3. The main body of the hood 3 has a first Shore A hardness rating of about 55 to about 60. Areas 8 and 9 have a second Shore A hardness rating of about 30 to about 35.

In the example illustrated in FIGS. 1 and 2, the two areas 8 and 9 comprise inserts received within corresponding openings formed in the wall of the hood 3, and are located in a position corresponding to contact areas of a cyclist's hand that are subjected to greater pressure. More precisely, area 8 comes in contact with the portion of the cyclist's hand located between the thumb and forefinger and area 9 that is positioned laterally shifted in the direction of the external side wall 3c with respect to area 8, comes in contact with the palm of the hand. In the case where the hood is associated with the ends of the handlebar, as mentioned above, areas of greater compliance are similarly located in a position corresponding to the portion of the cyclist's hand between the thumb and forefinger or in a position corresponding to the palm of the hand.

The areas of greater compliance than the main body the hood will be indicated below simply as areas of greater or increased compliance.

In a first embodiment, hood 3 is made of an elastomeric material, and the areas of increased compliance 8, 9 comprise inserts which are also made of an elastomeric material, but which present a greater compliance as compared to the main body of the sheath 3. Said result may be obtained by the use of an elastomeric material having a different hardness and/or density, or by an appropriate conformation of the inserts 8, 9, as will be described in detail below.

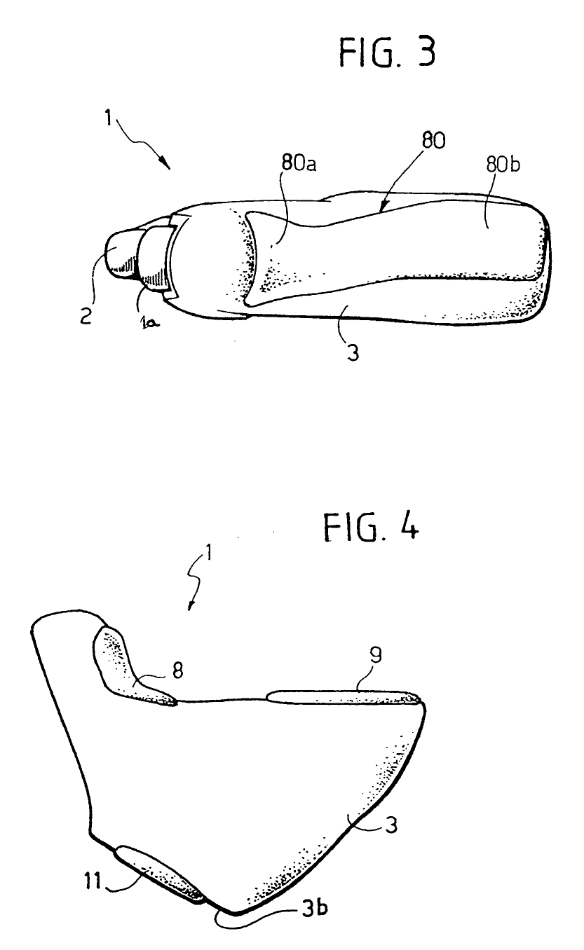

FIG. 3 illustrates an alternate embodiment having a single area of increased compliance 80, in a position corresponding to top wall 3a. Area 80 entirely covers a longitudinal zone extending from a front portion of top wall 3a, corresponding to an area 80a of contact of the cyclist's hand between the cyclist's thumb and forefinger, to a rear portion of top wall 3a, corresponding to an area 80b of contact of the cyclist's palm.

Furthermore, referring to FIG. 4, the hood according to the invention may also comprise a third area of increased compliance. As indicated by 11, the third area corresponds to the bottom surface 3b of the hood, where the cyclist's fingers (see FIG. 2) close around the body of the device 1. Like areas 8, 9, area 11 is defined by an insert mounted within a corresponding seat in the bottom wall 3b of the sheath 3. The material forming area 11 preferably has a Shore A hardness rating ranging from 30 to 35 as in areas 8 and 9.

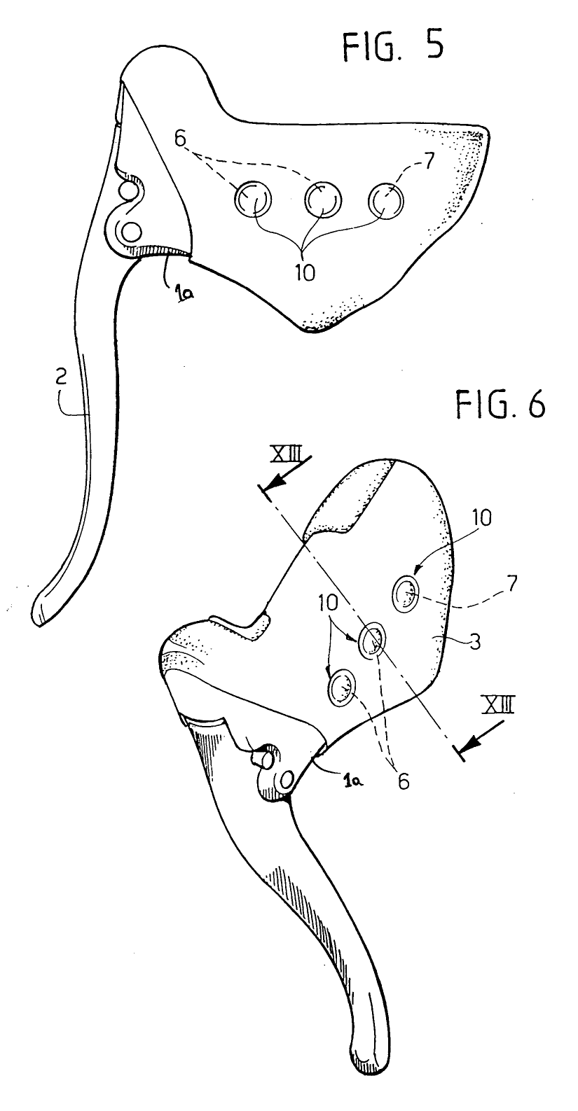

FIGS. 5 and 6 illustrate an alternate embodiment of the control device in which the derailleur actuation is controlled electronically. The control device comprises a pair of push-buttons 6, covered by corresponding portions 10 of the hood 3. The push-buttons 6 control the derailleur in upshifting and downshifting. FIGS. 5 and 6 further illustrate a third actuating push-button 7, designed to control the mode of operation of a display unit associated with a bicycle. Push-button 7 may likewise be provided in the “mechanical-shift” version illustrated in FIGS. 1, 2 and 14, on the inner side of the control 1.

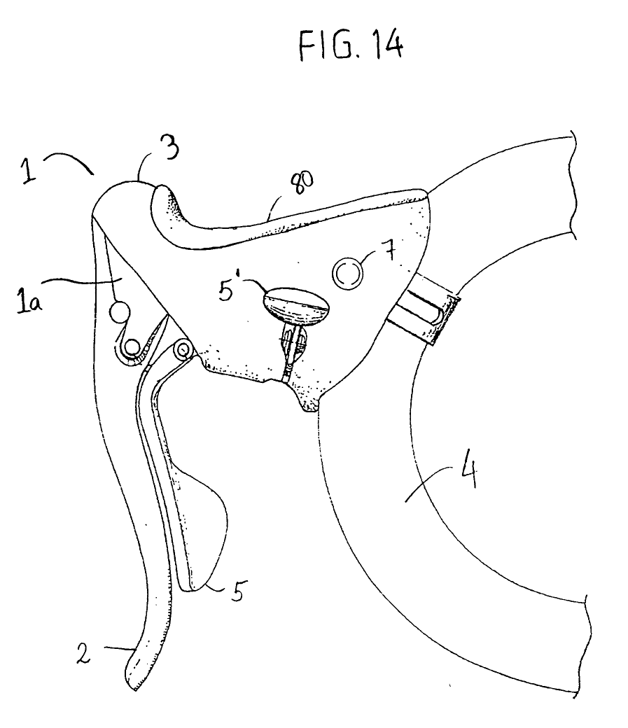

The hood further comprises three portions 10 that cover the push-buttons 6, 7, each defined by an insert (see also FIG. 13). The insert may be fixed in any known way, for example by vulcanization, within a respective seat 10a formed in the wall of the hood 3. The portions of sheath 10 are made of a material which has lower or decreased compliance with respect to the material of the main body the sheath, so as to provide to the cyclist a greater sensitivity in actuation. Such material preferably has a third Shore A hardness rating of about 80 to about 85 which is higher than that of the main body of the hood 3. Said portions 10, preferably but not necessarily, present an outer surface shaped and/or colored to facilitate identifying of the push-buttons by the cyclist.

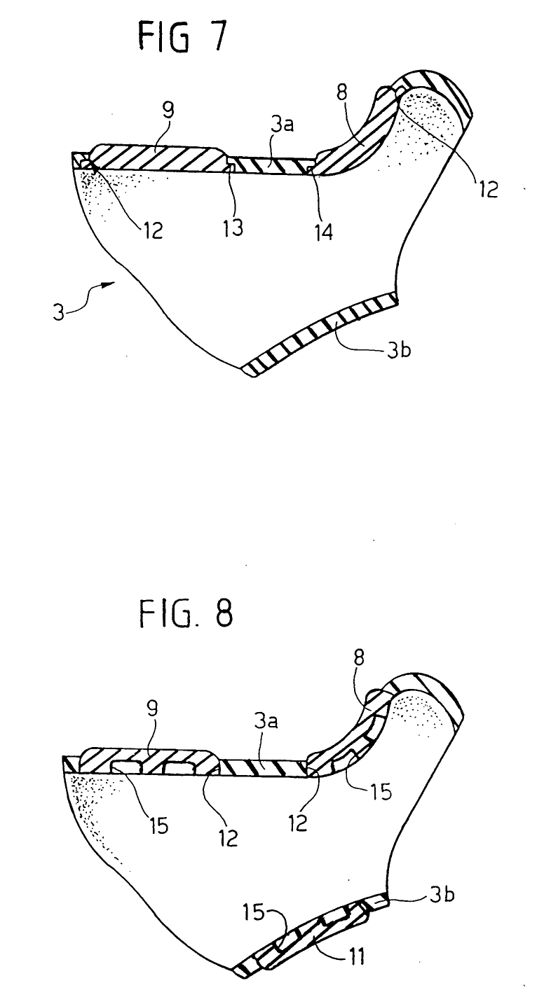

FIG. 7 illustrates a cross-sectional view in a longitudinal vertical plane of the hood 3 in the embodiment of FIGS. 1 and 2 comprising areas 8, 9 of increased compliance. FIG. 7 shows that each of said areas is defined by an insert made of an elastomeric material with a different density and/or hardness from those of the elastomeric material that forms the main body of the hood 3. Any suitable material, for example a synthetic material or a silicone material, may be used both for the hood 3, and for the inserts 8, 9. Each of said inserts is received, through a shape fit, in an opening 12 of the top wall 3a of the hood 3. The edge of the opening 12 comprises a lip 13, upon which a peripheral edge 14 of each insert matingly engages, so as to prevent the insert from coming out of the hood. In use, any sliding of insert 8, 9 out of the hood 3 in a direction towards the interior of the hood 3 is prevented by the surface of the body 1a on which the hood 3 is applied.

It should again be noted that the thickness of each insert 8, 9 in FIG. 7 is greater than the thickness of the wall 3a of the sheath, so that it projects from the adjacent surface of the hood. It is also possible to configure the inserts with their outer surfaces flush with the adjacent surface of the hood.

FIG. 8 illustrates a cross-sectional view of an alternate embodiment that also comprises a bottom insert 11. What is indicated above, regarding the material and the arrangement of the inserts 8, 9, is also applicable to the insert 11. The FIG. 8 embodiment's three inserts lack the lip 13; rather they are fixed to the edges of the respective openings 12 by vulcanizing.

Finally, as shown in FIG. 8, the inserts 8, 9, 11 comprise lightening grooves 15 that also define wall portions of reduced thickness that are more compliant.

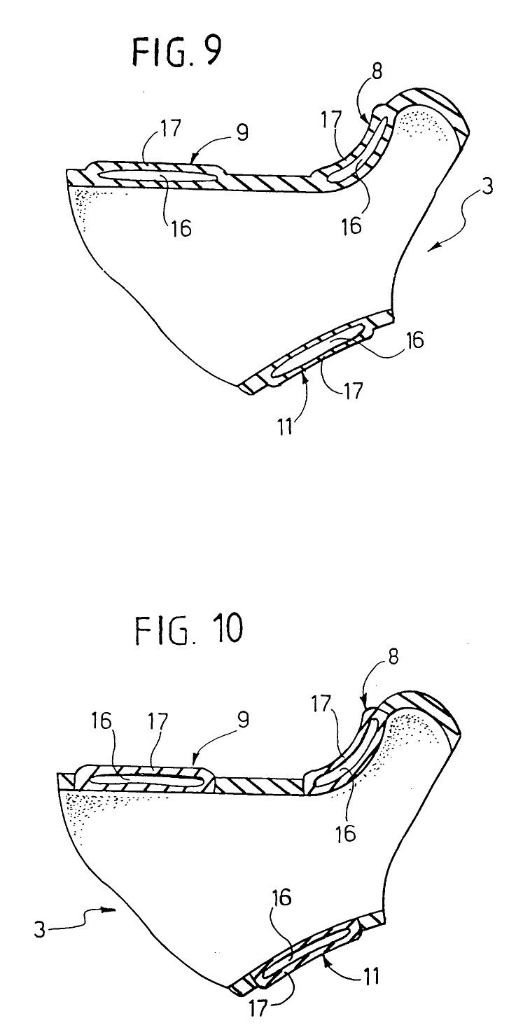

FIG. 9 shows an alternate embodiment in which the areas of increased compliance 8, 9, 11 are integral, i.e., of a single piece, with the hood 3. As shown in FIG. 9, each area is defined by a cushioned portion, containing a flattened cavity 16, which may for example be filled with a fluid, for example air, or a gas, or a liquid, or a material in the form of a gel or silicone material. Each cavity 16 thus defines a thin wall 17 functioning as a cushion.

FIG. 10 illustrates a similar solution to that of FIG. 9, with reference to cavities 16 filled with a fluid, but which, this time, are set inside fixed inserts within respective openings of the wall of the hood.

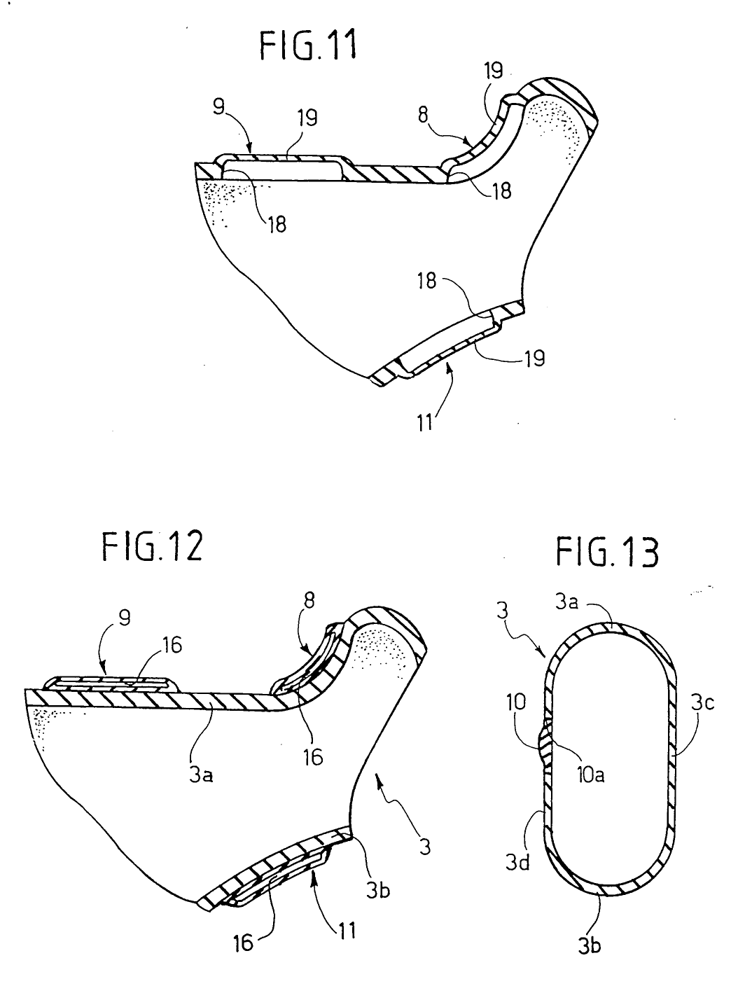

FIG. 11 illustrates a solution in which the hood 3 is made of a single piece and comprises, on its internal surface, open cavities 18 that define thin walls 19 in positions corresponding to the areas 8, 9, 11 that function as cushions. When mounted, the cavities 18 are closed by the surface of the body 1a on which the hood is mounted, and can receive a fluid within them, in a way similar to the embodiments illustrated in FIGS. 9 and 10.

FIG. 12 illustrates a further example, that differs from that of FIG. 10 in that the inserts are bonded or joined by molding on the outer surface of the sheath.

FIG. 13 highlights the detail, in a cross-sectional view, of the area of reduced compliance 10 associated with one of the push-buttons 6 consisting of an insert which, as previously mentioned, may be fixed to the hood 3 by vulcanizing. Any other known method of fixing may be used, such as for example a shape fit. It is then to be noted that the particular shape, which is slightly rounded towards the outside of said insert, can be easily found by the cyclist's thumb.

The hood may be prepared by firstly pouring a silicon rubber having a Shore A hardness rating of about 30 to about 35 in molds having the shape of the inserts 8, 9, 11 to be obtained, and then “partially” (preferably 50% cured) curing them. The partially cured inserts 8, 9, 11 are then placed in the appropriate places of a mold having the shape of the hood 3 to be obtained. A silicon rubber, preferably having a Shore A hardness rating of about 55 to about 60, is then poured in the mold so as to partially embed the softer inserts. Both the inserts and hood are then fully cured to form the hood. This is performed in two separate curing steps because the harder silicon rubber needs less curing time than the softer one. The curing time of the harder silicon rubber in the specific example is about half that of the softer one.

1. A covering hood for a bicycle component that is gripped or grasped when used, wherein the hood comprises a main body and at least one area of differentiated compliance with respect to the main body.

2. The hood of claim 1, wherein said at least one area of differentiated compliance provides a greater compliance than the main body of the hood.

3. The hood of claim 2, wherein said at least one area is associated with an area of contact of a cyclist's hand that grips said hood during use.

4. The hood of claim 2, wherein the hood comprises an internal side wall, an external side wall, and a top wall.

5. The hood of claim 4, wherein said at least one area of higher compliance is in a position corresponding to said top wall and entirely covers a longitudinal zone extending from a front portion of said top wall, in a position corresponding to an area of contact of the cyclist's hand defined between a cyclist's thumb and forefinger, to a rear portion of said top wall, corresponding to an area of contact of the cyclist's palm.

6. The hood of claim 4, wherein said at least one area of higher compliance is located in a portion of said top wall in a position corresponding to an area of contact of the cyclist's hand defined between a cyclist's thumb and forefinger.

7. The hood of claim 4, wherein said at least one area of higher compliance is located in a portion of said top wall in a position corresponding to an area of contact of a cyclist's palm.

8. The hood of claim 7, wherein said area of higher compliance is positioned laterally shifted in the direction of the external side wall.

9. The hood of claim 4, wherein the hood comprises a bottom wall.

10. The hood of claim 9, wherein said a least one area of higher compliance is located in said bottom wall of said hood in a position corresponding to points of contact of a cyclist's fingers when the cyclist grips the hood.

11. The hood of claim 2, wherein the hood comprises a second area of higher compliance than material of the main body of the hood.

12. The hood of claim 6, wherein the hood comprises a second area of higher compliance than material forming the main body of the hood and wherein said second area is located in a portion of said top wall in a position corresponding to an area of contact of a cyclist's palm.

13. The hood of claim 12, wherein said second area is laterally shifted in the direction of said external side wall with respect to said first area.

14. The hood of claim 11, wherein said hood comprises a third area of higher compliance than the material forming the main body of the hood.

15. The hood of claim 14, wherein said third area is located in a bottom wall of said hood in a position corresponding to points of contact of a cyclist's fingers when the cyclist grips the hood.

16. The hood of claim 1, wherein said area of different compliance provides a lower compliance than the material forming the main body of the sheath.

17. The hood of claim 16, wherein said area of lower compliance is provided in a position corresponding to at least one push-button, that can be actuated by pressure exerted by a cyclist.

18. The hood of claim 16, wherein said hood comprises a second area of lower compliance than the material forming the main body of the hood.

19. The hood of claim 18, wherein said second area of lower compliance is provided in a position corresponding to at least one push-button, that can be actuated by pressure exerted by a cyclist.

20. The hood of claim 18, wherein said hood comprises a third area of lower compliance than the material forming the main body of the sheath.

21. The hood of claim 20, wherein said third area of lower compliance is provided in a position corresponding to at least one push-button, which can be actuated by pressure exerted by a cyclist.

22. The hood of claim 16, wherein said area of lower compliance is located in an area that can be reached by a cyclist's thumb when a cyclist's hand is in an operative position for gripping said component.

23. The hood of claim 1, comprising at least one second area of differentiated compliance as compared to the material forming the main body of the sheath, said first area providing higher compliance and said second area providing lower compliance.

24. The hood claim 23, wherein said first area is located in an area of contact of a cyclist's hand that grips said hood, and said second area is located in a position corresponding to a push-button, that can be actuated by pressure exerted by a cyclist.

25. The hood of claim 23, wherein said hood comprises a second area of higher compliance than the material forming the main body of the hood.

26. The hood of claim 25, wherein said hood comprises a third area of higher compliance than the material forming the main body of the hood.

27. The hood of claim 23, comprising a second area of lower compliance than the material forming the main body of the hood.

28. The hood of claim 27, wherein said hood comprises a third area of lower compliance than the material forming the main body the hood.

29. The hood of claim 1, wherein said area is an insert associated to the hood.

30. The hood of claim 29, wherein said insert is made of a material which has a different hardness from the material forming the main body of the hood.

31. The hood of claim 29, wherein said insert is made of a material having an identical hardness as the material forming the main body of the hood and is conformed to provide said different compliance.

32. The hood of claim 30, wherein said hood is made of a first synthetic or elastomeric material and that said insert is made of a second synthetic or elastomeric material.

33. The hood of claim 29, wherein said insert is made of a synthetic or elastomeric material in solid or gel form.

34. The hood of claim 29, wherein said insert is made of a silicone material.

35. The hood of claim 29, wherein said insert is joined to the hood by means of a shape fit.

36. The hood of claim 29, wherein said insert is mounted within a through opening presenting a corresponding shape of a wall of the hood.

37. The hood of claim 36, wherein a surface of said opening defines a lip engaged by a peripheral portion of the insert so as to prevent the insert from coming out of said opening.

38. The hood of claim 29, wherein said insert is directly molded within a seat of the sheath.

39. The hood of claim 29, wherein said insert comprises an internal cavity.

40. The hood of claim 39, wherein said cavity is filled with a fluid chosen from the group consisting of: air, a liquid material, a gel material, and a silicone material.

41. The hood of claim 29, wherein said insert is inserted in a seat of the hood.

42. The hood of claim 29, wherein said insert is joined to an outer surface of the hood.

43. The hood of claim 1, wherein at least one area is defined by a part that is integral with the hood and is shaped so as to provide a desired degree of compliance.

44. The hood of claim 43, wherein said integral part presents an internal cavity.

45. The hood of claim 44, wherein said cavity is filled with a fluid chosen from the group consisting of: air, a liquid material, a gel material, and a silicone material.

46. The hood of claim 43, wherein said integral part is thinner than the main body of the hood.

47. The hood of claim 46, wherein said thinner part is distanced from an internal surface of the hood.

48. The hood of claim 43, wherein said integral part defines a closed cavity in co-operation with a surface of a body on which the hood is mounted.

49. The hood of claim 1, wherein said at least one area is optically distinguishable from the main body of the hood with regard to color, shape, decoration, or surface characteristics.

50. The hood of claim 1, wherein said at least one area has an outer surface flush with respect to the outer surface of the hood.

51. The hood of claim 1, wherein at least one area has an outer surface projecting with respect to an outer surface of the hood.

52. A hood for covering a bicycle control device comprising a first side wall, a second side wall and a top wall, wherein the hood comprises at least one area having a greater compliance than a main body of the hood in a position corresponding to said top wall and entirely covering a zone extending longitudinally from a front portion of said top wall, in a position corresponding to an area of contact between a cyclist's thumb and forefinger, to a rear portion of said top wall, in a position corresponding to an area of contact of a cyclist's palm.

53. The hood of claim 52, further comprising a bottom wall.

54. The hood of claim 53, wherein said bottom wall comprises an area of greater compliance which contacts a cyclist's fingers when said control device is grasped.

55. The hood of claim 52, wherein the at least one area of greater compliance comprises at least one insert.

56. The hood of claim 55, wherein the at least one insert is secured to the hood by vulcanization.

57. The hood of claim 55, wherein the at least one insert is secured to the hood by a shape fit.

58. A hood for covering a control device of a bicycle wherein the hood comprises at least one area of decreased compliance than a main body of the hood.

59. The hood of claim 58, wherein the at least one area of decreased compliance is located in a position corresponding to a push-button of the control device.

60. The hood of claim 59, wherein the at least one area of decreased compliance allows a cyclist to actuate said push-button.

61. The hood of claim 59, wherein the push-button controls an electronic gear shift event.

62. The hood of claim 59, wherein the push-button controls a cycle computer function.

63. The hood of claim 58, wherein the hood further comprises at least one area of greater compliance than the main body of the hood.

64. The hood of claim 63, wherein the at least one area of greater compliance is located in a position that comes in contact with a portion of a cyclist's hand when the device is used.

65. The hood of claim 63, wherein the at least one area of greater compliance is integral with the material comprising the main body of said hood.

66. The hood of claim 63, wherein the at least one area of greater compliance comprises a different material than the material comprising the main body of said hood.

67. The hood of claim 63, further comprising a first side wall, a second side wall and a top wall.

68. The hood of claim 67, wherein said at least one area of greater compliance is in a position corresponding to said top wall and entirely covers a zone extending longitudinally from a front portion of said top wall, in a position corresponding to an area of contact between a cyclist's thumb and forefinger, to a rear portion of said top wall, in a position corresponding to an area of contact of a cyclist's palm.

69. The hood of claim 67, further comprising a bottom wall.

70. The hood of claim 69, wherein said bottom wall comprises an area of greater compliance which contacts a cyclist's fingers when said control device is grasped.

71. The hood of claim 63, wherein the at least one area of greater compliance comprises at least one insert.

72. The hood of claim 71, wherein the at least one insert is secured to the hood by vulcanization.

73. The hood of claim 72, wherein the at least one insert is secured to the hood by a shape fit.

74. A covering hood for a body that can be associated to the handlebar of a bicycle, wherein the hood comprises a main body and at least one area of differentiated compliance with respect to the main body.

75. A covering hood for a body designed to be fixed to the handlebar of a bicycle and forming the support of a lever for actuation of the brake of the bicycle, wherein the hood comprises a main body and at least one area of differentiated compliance with respect to the main body.

76. A covering hood for a body designed to be fixed to the handlebar of a bicycle and forming the support of an integrated control for a bicycle, wherein the hood comprises a main body and at least one area of differentiated compliance with respect to the main body.

77. A covering hood for the ends of a bicycle handlebar, wherein the hood comprises a main body and at least one area of differentiated compliance with respect to the main body.

78. A process for manufacturing a hood for a bicycle component, the process comprising the steps of:
a) providing at least one insert mold;
b) introducing a first silicon rubber having a first Shore A hardness into said at least one insert mold;
c) partially curing said silicon rubber and thereby forming at least one partially cured insert;
d) providing a mold having the shape of the hood to be obtained;
e) placing said at least one partially cured insert in said mold having the shape of the hood to be obtained;
f) introducing a second silicon rubber, having a second Shore A hardness that is different from the first Shore A hardness into the mold to embed the at least one partially cured insert;
g) fully curing the at least one partially cured insert and the second silicon rubber to form the hood; and
h) removing the hood from the mold.

79. The process of claim 78, wherein time required for curing in step g is approximately equal to time required to partially cure of step c.

80. The process of claim 78, wherein the first Shore A hardness is less than the second Shore A hardness.

81. The process of claim 78, wherein the first Shore A hardness is a value of about 30 to about 35.

82. The process of claim 78, wherein the second Shore A hardness is a value of about 55 to about 60.
